(19) United States
(12) Patent Application Publication
(10) Pub. No.: US 2004/0112967 A1
(43) Pub. Date: Jun. 17, 2004

(54) Smart card web and a method for its manufacture

(75) Inventors: Anu Krappe, Tampere (FI); Samuli Stromberg, Tampere (FI); Mikko Tirkkonen, Tampere (FI); Minna-Mari Reunanen, Tampere (FI)

Correspondence Address: FITCH EVEN TABIN AND FLANNERY, 120 SOUTH LA SALLE STREET, SUITE 1600, CHICAGO, IL, 60603-3406, US

(73) Assignee: Rafsec Oy

(21) Appl. No.: 10/674,258

(22) Filed: Sep. 29, 2003

Related U.S. Application Data
(63) Continuation of application No. PCT/FI02/00219, filed on Mar. 18, 2002.

(30) Foreign Application Priority Data
Apr. 6, 2001 (FI) 20010719

(51) Int. Cl. G06K 19/06

(52) U.S. Cl. 235/492

(57) ABSTRACT

The present invention relates to a smart card web comprising a carrier web which comprises circuitry patterns, each having an integrated circuit at suitable spaces one after another and/or next to each other and at least one cover web attached to the carrier web. The carrier web and the cover web are attached by a thermoplastic adhesive bonding film web.

The present invention relates to a smart card web comprising a carrier web which comprises circuitry patterns, each having an integrated circuit, at suitable spaces one after another and/or next to each other and at least one cover web attached to the carrier web. The present invention also relates to an intermediate product for producing a smart card comprising a carrier sheet which comprises at least one circuitry pattern having an integrated circuit and at feast one cover sheet attached to the carrier sheet.

The smart card web is normally used as a raw material for further processing in the manufacture of contactless smart cards. The smart cards are rigid or semi-rigid cards having a laminated structure. The smart card comprises a so-called radio frequency identification (RFID) circuit which is typically used at a distance of some tens of centimetres from a reader antenna. Such a smart card can be used for example as an electrical purse, as a ticket in public service vehicles, or for personal identification.

A majority of smart cards according to prior art are laminated from polyvinyl chloride layers (PVC) of different thicknesses, their adhesion being based on heat-sealability between the layers. Apart from the heat-sealability, PVC has the advantage of being easily subjected to further processing. Another material used is acrylonitrile/butadiene/styrene (ABS) copolymer which is a harder material than PVC and thus more difficult to process.

Another common technique to produce smart cards is injection moulding. In addition to these most common techniques, adhesives to attach the different material layers are also used. Such adhesives include for instance polyurethane-based two-component adhesives.

An integrated circuit on a chip is normally first attached to a module by wire bonding, a solder FC joint or an adhesive joint (ICA, ACA, NCA), or by another technology suitable for the attachment of the bare chip. After the attachment, the chip is protected with an epoxy drop. In the next step, the module is attached to the conductive circuit. The most preferred methods for attaching the module are adhesive joints curable at a low temperature, a wire bond formed by utilizing ultrasound, or mechanical bonding methods, such as crimp connection.

One problem has been that it has not been possible to use direct bonding methods requiring high temperatures in the attachment of the integrated circuit on the chip, because the commonly used materials on whose surface the circuitry pattern is formed, such as PVC or ABS, do not tolerate temperatures exceeding a maximum of about 110° C. without softening. For this reason, the process temperatures must be limited, and a complex technique and time-consuming methods must be used for attaching the integrated circuit on the chip. The above-mentioned methods also involve extra material consumption. On the other hand, if a material resistant to a high temperature were used, its further processability would be poor, because the heat-sealability would be substantially impaired. In this case, the layers would have to be attached by adhesive lamination, which is a relatively complex method to be used in this connection. There is also a danger that a brittle chip is damaged when the adhesive is applied to the surface of the carrier web. In addition, the adhesives may contain harmful solvents.

By means of a smart card web according to the invention, it is possible to avoid the above-mentioned problems. A smart card web according to the invention is characterized in that the carrier web and the cover web are attached by a thermoplastic adhesive bonding film. An intermediate product according to the invention is characterized in that the carrier sheet and the cover sheet are attached by a thermoplastic adhesive bonding film.

The smart card web according to the invention has several advantages. The material of the carrier web can be selected according to the requirements of the bonding technique of the integrated circuit on the chip irrespective of the heat-sealability of the material. The thermoplastic adhesive bonding film does not contain harmful substances, such as solvents, which could evaporate to air and cause irritations for people close to the process line. The thermoplastic adhesive bonding film is easy to process and it does not require any actions before attaching the different material layers of the smart card web, for example application of an adhesive on the surface of the carrier web. The thermoplastic adhesive bonding film can be processed as a continuous web. Thus the process line is cost-effective and suits well to mass-production. The thermoplastic adhesive bonding film and/or the cover web protects the circuitry pattern on the carrier web and the integrated circuit on the chip from the effects of e.g. chemicals and ambient conditions.

The smart card web according to the invention comprises at least one cover web and a carrier web, attached to each other by means of an thermoplastic adhesive bonding film. Thermoplastic adhesive bonding films are adhesives which are activated by a combination of heat, pressure and dwell time. Typical characteristic for the thermoplastic adhesive bonding film is that it is non-sticky at room temperature but becomes sticky and adheres when it is warmed up. This behaviour is reversible.

The structure of the smart card web may contain several cover web layers which are attached to each other by thermoplastic adhesive bonding films. At least the cover web which is in contact with the chip (a thermoplastic adhesive bonding film being between the chip and the cover web) is provided with a cavity in which the integrated circuit on the chip fits. The cavity enables an even surface for the smart card because otherwise the chip would have caused a bulge on the surface of the smart card. A bulge on the surface of the smart card web is not desirable because then the brittle chip can easily be broken. In addition to the innermost cover web, other cover webs may also be provided with a cavity but this embodiment impairs the ability of the structure of the smart card web to protect the chip against external effects, such as impurities and humidity.

The surface of the carrier web is provided with successive and/or parallel circuitry patterns which are each equipped with an integrated circuit on a chip. The carrier web preferably bears well high temperatures which are used in some methods for attaching the integrated circuit on the chip to a circuitry pattern.

One important attachment method is the flip-chip technology which comprises several techniques. The flip-chip technology can be selected upon using materials according to the invention from a large variety in such a way that the production rate of the process can be maximized at an appropriate level of quality and reliability. Suitable flip-chip methods include anisotropically conductive adhesive or film (ACA or ACF) joint, isotropically conductive adhesive (ICA) joint, non-conductive adhesive (NCA) joint, solder flip-chip (FC) joint, or possibly other metallic joints. In addition to the flip-chip technology, also a wire bond or a joint made by tape automated bonding (TAB) can be used.

Also, a joint made without a conventional underfill by a thermoplastic anisotropically conductive film or a thermoplastic non-conductive adhesive film is possible. The thermoplastic anisotropically conductive film or the thermoplastic non-conductive film is attached on the bumped chip and then the bumped chip provided with the meltable film is attached on the circuitry pattern by the flip-chip technology. Such thermoplastic films are for example anisotropic conductive films 8773 and 8783 (Z-Axis Adhesive Films 8773 and 8783, 3M, USA).

Possible materials for the cover web include polyvinyl chloride (PVC), polyester (PET), polycarbonate (PC), acrylonitrile/butadiene/styrene (ABS), polypropylene (PP) and polyethylene (PE). The material of the cover web can also be another suitable material because neither resistance to heat nor heat-sealability are critical in this context. Possible material for the carrier web is for example polyester (PET), polycarbonate (PC), acrylonitrile/butadiene/styrene (ABS), polypropylene (PP), polyethylene (PE), polyimide (PI) or polyolefin blends. The material of the carrier web can also be another suitable material whose thermal resistance properties are at least equal to those of the above-mentioned material. The selection of materials of the carrier web and the cover web/webs depends also on the desired rigidity of the smart card, for example when a smart card is rather flexible, more actions to protect the chip are needed. The materials are selected so that bending of a smart card with a small radius is not possible without breaking the card.

The attachment of the integrated circuit on the chip to the carrier web can be performed on the same production line as the attachment of the cover web and the carrier web to each other, or on a separate production line. After the lamination, the smart card web is normally sheeted so that it can be subjected to further processing in sheet form.

The temperatures which the carrier web must tolerate upon the attachment of the chip vary according to the technology. They are often higher than 110° C. When epoxy-based adhesives are used in an anisotropically conductive adhesive bond or in a non-conductive adhesive bond, the required process temperatures are typically higher than 140° C. This is the case also in an isotropically conductive adhesive bond. When a solder bump joint is used, the highest temperatures used are typically about 220° C. In the bonds, it is also possible to use thermoplastic, polymer-based adhesives whose process temperatures range from about 140 to 200° C.

Thermoplastic adhesive bonding films are films which are attached to a substrate by means of heat and pressure. At the room temperature the films have no adherance but when heated, they become tacky. When the temperature of the film falls again to the room temperature, it has no adherance but the bonds formed with other surfaces during heating remain. The preferred thermoplastic adhesive bonding films are based on modified polyolefins or modified polyurethanes.

Suitable thermoplastic adhesive bonding films are for example 3M™ Thermo-Bond Film 845, 3M™ Thermo-Bond Film 845 G (Thermo-Bond Film products from 3M, USA), EAF-200, EAF-220, EAF-240, UAF-420, UAF-430 and UAF-440 (EAF and UAF products from Adhesive Films, Inc., USA).

Thermo-Bond Films 845 and 845 G are flexible and light-coloured thermoplastic adhesive bonding films. They are based on modified polyolefin. EAF-200 is a clear film based on ethylene copolymer, EAF-220 is a clear film based on ethylene vinyl acetate copolymer and EAF-240 is based on a similar compound as EAF-200 but has a higher melting point. UAF-420, UAF-430 and UAF-440 are films based on polyurethanes. They are clear or translucent.

The carrier web and the cover web/webs are attached by a thermoplastic adhesive bonding film/films. The attachment can be made in one process step, i.e. all the material layers are attached at the same time, or in several process steps, for example first attaching one thermoplastic adhesive bonding film on the carrier web, on that side where the chip is attached and later attaching the other layers.

The use of the thermoplastic adhesive bonding films makes it possible to use different lamination techniques. The basic methods for lamination are pressing in a press or pressing in a nip formed between two counter surfaces. By using pressing in a nip it is possible to attain a continuous process. At least one of the counter surfaces forming the nip may be heatable or the thermoplastic adhesive bonding film may be heated so that it becomes tacky before the nip. The process temperatures normally vary from 120° C. to 170° C.

There must also be a certain dwell time in the nip which is normally from 2 to 15 seconds. The term dwell time refers to the period of time during which the smart card web stays in the nip. The used pressure in the nip varies from 60 to 700 kPa, depending on the thermoplastic adhesive bonding film. To obtain an optimum dwell time and pressure in the nip, the nip is preferably a nip longer than a nip formed by hard rolls. The nip can be for example a nip formed by a thermoroll and a resilient roll, wherein the pressure per unit area is lower than in a corresponding hard nip. One of the contact surfaces forming the nip can also be a shoe roll. The nip dwell time and pressure are selected according to the requirements of the thermoplastic adhesive bonding film in question.

A smart card web according to the invention can be sheeted after manufacturing to form an intermediate product before manufacturing a smart card or an intermediate product for producing a smart card can be manufactured from the beginning in the sheet form. The sheets forming different layers of a smart card, i.e. a carrier sheet and a cover sheet/sheets, can be attached in a press by using thermoplastic adhesive bonding films between different layers. The carrier sheet may include more than one circuitry pattern having an integrated circuit on a chip. The structure of the cross section of the intermediate product is similar to the cross section of the smart card web.

In the following, the invention will be described by means of drawings, in which,

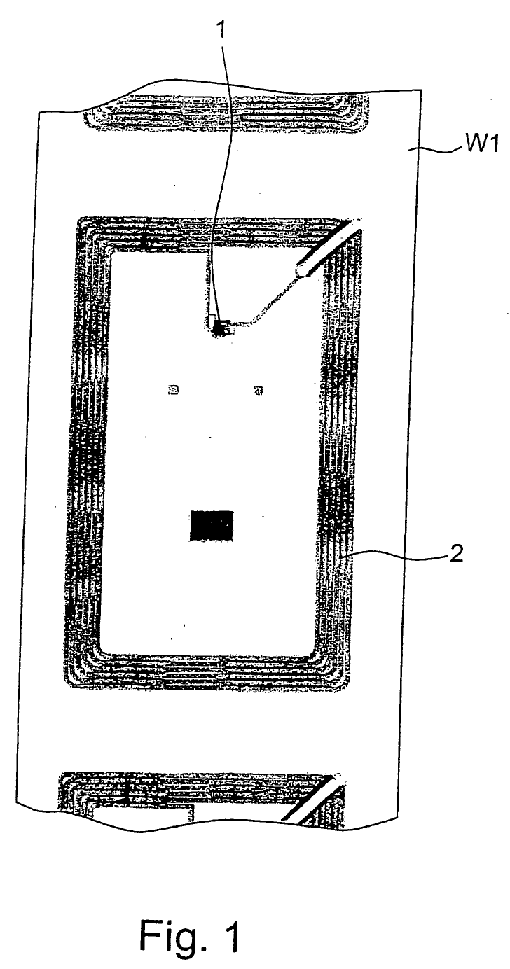

FIG. 1 shows a carrier web in a top view,

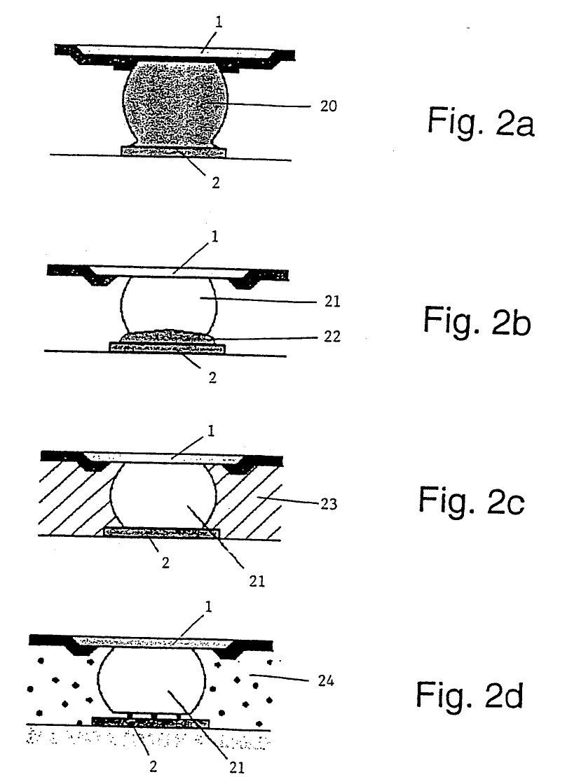

FIGS. 2a-2d shows various techniques for attaching an integrated circuit on a chip in a side view,

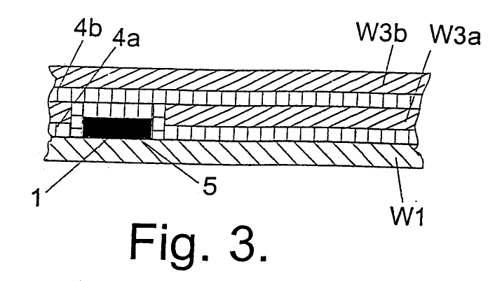

FIG. 3 shows a side view of a smart card web, and

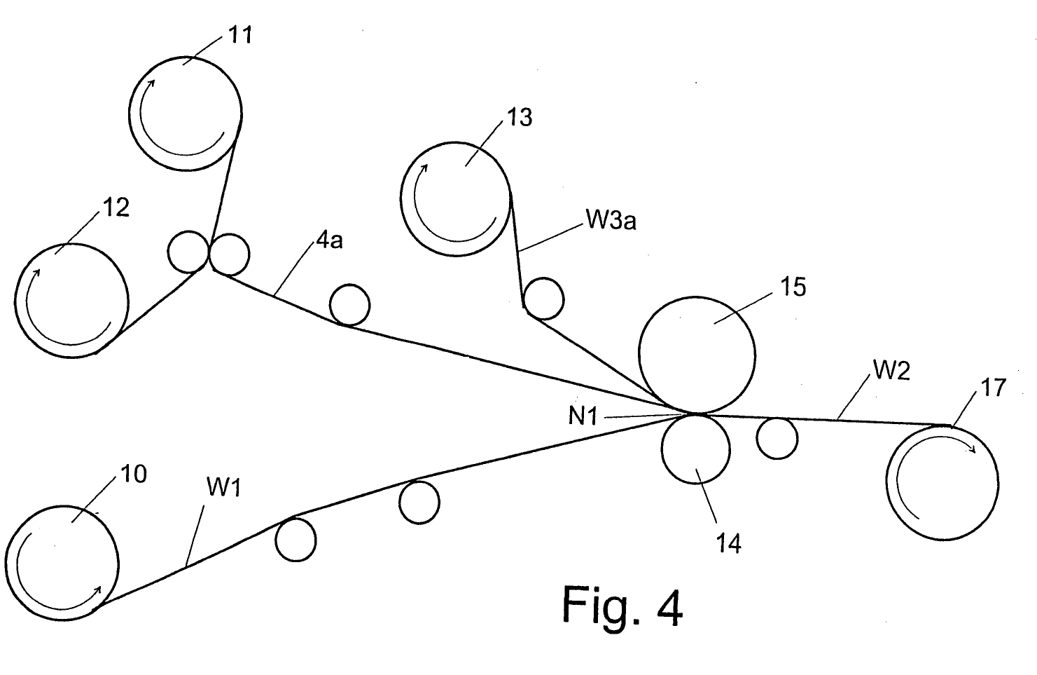

FIG. 4 shows a side view of a manufacturing line of a smart card web.

FIG. 1 shows a carrier web W1 in a top view. The material of the carrier web W1 is a material resistant to relatively high temperatures, such as polyester. Thus, methods for attaching an integrated circuit on a chip which require high temperatures can also be used. The carrier web W1 contains a single circuitry pattern 2 and an integrated circuit 1 therein. The carrier web W1 contains circuitry patterns 2, each having an integrated circuit 1, at suitable spaces one after another and/or next to each other. The circuitry pattern can be made by printing the circuitry pattern on a film with an electroconductive printing ink, by etching the circuitry pattern on a metal film, by punching the circuitry pattern off a metal film, or by winding the circuitry pattern of e.g. a copper wire. The circuitry pattern is provided with an identification circuit, such as a radio frequency identification (RFID) circuit. The identification circuit is a simple electric oscillating circuit (RCL circuit) tuned to operate at a defined frequency. The circuit consists of a coil, a capacitor and an integrated circuit on a chip, consisting of an escort memory and an RF part for communication with a reader device. The capacitor of the RCL circuit can also be integrated on the chip.

FIGS. 2a to 2d show possible techniques of attachment to be used for the attachment of an integrated circuit 1 to the circuitry pattern 2 on the carrier web W1. FIG. 2a shows a solder bump 20, by which the integrated circuit on the chip 1 is attached to the circuitry pattern 2. The solder bump 20 is made of a soldering paste.

FIG. 2b shows a joint, in which an isotropically conductive adhesive 22 is attached to the circuitry pattern 2. A solder bump 21, which can be made of gold or a mixture of gold and nickel, is attached to the isotropically conductive adhesive. The solder bump 21 is provided with the integrated circuit on the chip 1.

FIG. 2c shows a joint, in which a solder bump 21 is attached between the circuitry pattern 2 and the integrated circuit on the chip 1 and is encapsulated by a non-conductive adhesive 23.

FIG. 2d shows a joint, in which a solder bump 21 is attached between the circuitry pattern 2 and the integrated circuit on the chip 1 and is encapsulated by an anisotropically conductive adhesive 24.

FIG. 3 shows a smart card web W2 comprising a carrier web W1. The carrier web W1 is preferably made of polyester which tolerates well high process temperatures. The surface of the carrier web W1 is provided with circuitry patterns 2 (shown in the FIG. 1) by printing the circuitry pattern on a film with an electroconductive printing ink, by etching the circuitry pattern on a metal film, by punching the circuitry pattern off a metal film, or by winding the circuitry pattern of e.g. a copper wire. The circuitry pattern is provided with the integrated circuit on the chip 1. The integrated circuit 1 can be attached to the circuitry pattern by a suitable flip-chip technique, such as anisotropically conductive adhesive or film (ACA or ACF) joint, isotropically conductive adhesive (ICA) joint, non-conductive adhesive (NCA) joint, solder flip-chip (FC) joint, or possibly another metallic joint. Also, a joint made without an underfill by a thermoplastic anisotropic conductive film or a thermoplastic non-conductive adhesive film is possible. Such films are for example anisotropic conductive films 8773 and 8783 (Z-Axis Adhesive Films 8773 and 8783) by 3M.

Cover webs W3a and W3b are attached to the carrier web W1 by thermoplastic adhesive bonding film webs 4a and 4b. The material of the cover webs W3a and W3b is preferably polyester or polyvinyl chloride. The thermoplastic adhesive bonding films are based on modified polyolefin or modified polyurethane. The properties of some suitable thermoplastic adhesive bonding films are shown in table 1. The process conditions which are required for attaching surfaces together by using said thermoplastic adhesive bonding films are also shown in table 1.

The cover web W3a is provided with a cavity 5 in which the integrated circuit on the chip 1 fits. The cavity 5 enables an even surface for the smart card because otherwise the chip would cause a bulge on the surface of the smart card. The cavity 5 may be formed by a hole in the cover web or by a recess which does not extend through the whole-thickness of the cover web W3a. The hole is made by punching the cover web W3a.

On the cover web W3a another cover web W3b is attached by using a thermoplastic adhesive bonding film web 4b. Depending on the required rigidity of the smart card, some layers of the cover web may be excluded. When the cover web W3a with the cavity 5 forms the outermost layer of the smart card web W2, the thermoplastic adhesive bonding film web 4a forms a protective layer on the chip and thus the chip 1 is shielded against external effects, such as humidity.

It is also possible that a layer/layers of the cover web is/are added by a thermoplastic adhesive bonding film on the other side of the carrier web W1 to support the smart card, that is to say to give extra rigidity to the smart card. The supporting layer is preferably made of polyvinyl chloride or polyester.

FIG. 4 shows a side view of an embodiment of a manufacturing line of a smart card web W2. The ready smart card web is formed of a carrier web W1 and a cover web W3a which are attached to each other by means of a thermoplastic adhesive bonding film web 4a. The carrier web W1 comprising circuitry patterns 2, each having an integrated circuit 1, at suitable spaces one after another and/or next to each other, is unwound from a roll 10. The thermoplastic adhesive bonding film web 4a is unwound from a roll 11. The thermoplastic adhesive bonding film is often provided with a release paper. The release paper is wound to a roll 12. The cover web W3a is unwound from a roll 13. The cover web W3a contains punched cavities 5 (shown in FIG. 3) in which the integrated circuits on the chips 1 (shown in FIGS. 1 and 3) are fitted.

The carrier web W1, the thermoplastic adhesive bonding film web 4a and the cover web W3a are guided together into a nip N1 in which the webs are attached to form a smart card web W2. The nip N1 is preferably a nip longer than a nip formed by hard rolls. The nip N1 is formed by a thermoroll 14 and a resilient roll 15, wherein the pressure per unit area is lower than in a corresponding hard nip. One of the contact surfaces forming the nip can also be a shoe roll. It is also possible that the heating takes place before the nip, wherein the thermoplastic adhesive bonding film web is heated for example by blowing hot air towards the web. The nip dwell time and pressure are selected according to the requirements of the thermoplastic adhesive bonding film in question. The ready smart card web is wound on a roll 16.

The above description does not restrict the invention, but the invention may vary within the scope of the claims. The materials of the carrier web and the cover web can be different from those presented above. The main idea in the present invention is that when material layers of a smart card are attached to each other by using thermoplastic adhesive bonding films, it is possible to select the material of a layer in the smart card from a great variety of materials because the heat-sealability requirements can be ignored. In addition, harmful substances, such as solvents, can be avoided in the process.

TABLE 1
Properties of some suitable thermoplastic adhesive bonding films.

| | | | | Process conditions | | |
|---|---|---|---|---|---|---|
| | Thickness | | Melting | Temperature | Pressure | Dwell |
| Product | (μm) | Hardness | point (° C.) | (° C.) | (kPa) | time (s) |
| Thermo-Bond | 101 | — | — | 121-132 | 69-147 | 2-5 |
| Film 845 | | | | | | |
| Thermo-Bond | 63 | — | — | 121-132 | 69-147 | 2-5 |
| Film 845 EG | | | | | | |
| EAF-200 | 101.6 | 80 A | 82.2-93.3 | 107.2-135 | 276-614 | 2-5 |
| EAF-220 | 101.6 | 80 A | 76-87.8 | 93.3-121.1 | 276-614 | 2-5 |
| EAF-240 | 76.2 | 80 A | 98.9-110 | 121.1-148.8 | 276-614 | 2-5 |
| | 152.4 | | | | | |
| UAF-420 | 76.2 | 86 A | 82.2-93.3 | 121-176.6 | 614-552 | 5-10 |
| | 152.4 | | | | | |
| UAF-430 | 76.2 | 90 A | 129.4-140.6 | 148.8-176.6 | 614-483 | 4-6 |
| | 101.6 | | | | | |
| UAF-440 | 0.0508 | 95 A | 176.7-187.8 | 204.4-246.1 | 614-689 | 5-15 |
| | 0.0889 | | | | | |

1. A smart card web comprising a carrier web which comprises circuitry patterns, each having an integrated circuit, at suitable spaces one after another or next to each other and at least one cover web attached to the carrier web wherein the carrier web and the cover web are attached by a thermoplastic adhesive bonding film web.

2. The smart card web according to claim 1, wherein the smart card web comprises several cover web layers which are attached to each other by thermoplastic adhesive bonding film webs.

3. The smart card web according to claim 2, wherein the material of the thermoplastic adhesive bonding film is based on modified polyolefin or modified polyurethane.

4. The smart card web according to claim 1, wherein the carrier web is made of polyester.

5. The smart card web according to claim 1, wherein the cover web is made of polyvinyl chloride or polyester.

6. The smart card web according to claim 1, wherein at the location of the chip there is a cavity in the cover web.

7. The smart card web according to claim 1, wherein the thermoplastic adhesive bonding film web is arranged to cover the chip.

8. An intermediate product for producing a smart card comprising a carrier sheet which comprises at least one circuitry pattern having an integrated circuit and at least one cover sheet attached to the carrier sheet, wherein the carrier sheet and the cover sheet are attached by a thermoplastic adhesive bonding film.
